(19) United States
(12) Patent Application Publication
(10) Pub. No.: US 2006/0246196 A1
(43) Pub. Date: Nov. 2, 2006

(54) Low-alcohol, low-calorie wine

(76) Inventor: John A. Lawson, Napa, CA (US)

Correspondence Address: JAMES R. CYPHER, 405 14TH STREET, SUITE 1607, OAKLAND, CA, 94612, US

(21) Appl. No.: 11/115,619

(22) Filed: Apr. 27, 2005

(51) Int. Cl. A23L 1/236

(52) U.S. Cl. 426/548

(57) ABSTRACT

A process for making a low-alcohol, low-calorie wine is provided, as well as a composition thereof. The process includes the steps of providing a wine with a low alcohol content and then blending additives to achieve the character of a full-alcohol wine. Methods of providing a wine with a low-alcohol content include separating alcohol from full-alcohol wines or using grapes in the mash with a lower sugar content prior to fermentation. In one method of making a low-alcohol wine to which flavors can be added, regular, full-alcohol wine is reduced to 0.5-1.5% alcohol content through traditional de-alcoholization processes (for example spinning cone separation, evaporation, or membrane filtration under high pressure), and then blended with a fraction of the same full alcohol wine to achieve a wine with less alcohol than regular wines. Flavoring is added to this mixture.

### BACKGROUND OF THE INVENTION

This invention relates to a method of modifying the flavor of low-alcohol, low-calorie wine and to a composition comprised of a low-alcohol, low-calorie wine and a reduced-calorie flavor modifier or sweetener.

The production of wines from fermented sugars found in grapes dates back to antiquity. The particular taste, aroma, and character of a wine is due to the grapes themselves and to the substances which are produced during fermentation, processing and maturation of the wine. The selection and growing of the grapes and the production processes are manipulated to obtain the desired aroma, taste, and other characteristics of the wine.

In some instances, it has been found desirable to modify the flavors of wines after the fermentation, and maturation of the product.

The inventor has found that is often desirable to modify the flavor of low alcohol wines, and that there is a need for a full-flavored wine that is both low in calories and low in alcohol content.

It is believed that this need has become especially acute, since the alcohol content in wines has been trending higher. Traditionally, wines were typically made with alcohol levels in the 12% range. Today it is difficult to find a Chardonnay with less than 13.5% alcohol and a Merlot, or any red wine, with less than 14%.

In the United States, the so-called Baby Boomers are turning 50 at a rate of 11,000 per day. As of 2005, persons over 50 years of age comprised 77.6 million people or approximately one third of the U.S. population. Generally, as a person ages, they should consume less alcohol and less calories for health reasons. Thus, the demand for low-alcohol wines is expected to increase.

Also, other persons may desire a full-flavored, low-alcohol, low-calorie product, because they want to avoid the immediate effects of consuming too much alcohol, such as impaired judgment and slower reflexes.

The present invention meets the needs of persons who do not want to give up enjoying wine, yet cannot or should not consume as much alcohol in full-alcohol wines or should reduce their calorie intake or both.

Unfortunately, it has proven difficult to make a full-flavored low-alcohol wine that also has reduced calories. Ethyl alcohol, because of its chemical nature and sensory properties, exerts a number of positive influences upon wine. The molecule is a flavor enhancer as well as a mouth-feel modifier and, within reason, increasing levels of it will tend to make the flavor and mouth feel of the entire product more intense. Conversely, when the levels of alcohol are lowered, the opposite effect is seen.

The present invention creates a low-alcohol, low calorie wine with the mouth feel, aroma, and character of a traditional wine.

### SUMMARY OF THE INVENTION

The present invention provides a method of modifying the flavor of a low-alcohol wine by mixing a major amount by weight of the low-alcohol wine with a minor amount by weight of a reduced calorie sweetener. Preferably, the minor amount of the reduced calorie sweetener being less than 5% by weight of the resulting mixture.

Using a reduced calorie sweetener, which is defined as sweeteners having less calories than common sugars, such as sucrose, glucose (dextrose), lactose and fructose (levulose), and even no calories, to improve the flavor of wine, results in a number of benefits. First, when the alcohol content in a wine is reduced the calories in the wine are also reduced. By using a reduced calorie sweetener, non-calorie or low-calorie, to return the wine to its full-flavor, the low calorie nature of the low alcohol wine is retained. Secondly, the inventors have found that using the sweetener identified as sucralose, unexpectedly improves the mouth feel of the wine over other sweeteners. Sucralose also adds a clean character on the pallet, as well as body and sweetness to the wine, and it reduces the perception of astringency. Furthermore, because it is a no-calorie sweetener, it does not change the low calorie content of the low alcohol wine.

The present invention also provides a beverage composition comprising a major amount by weight of a low-alcohol wine and a minor amount by weight of a low-calorie sweetener composition, said minor amount being less than 5% by weight of the resulting mixture.

### DETAILED DESCRIPTION OF THE PREFERRED EMBODIMENT

In the preferred process for making a low-alcohol, low-calorie wine, first the alcohol content of a fraction of a regular-alcohol wine is reduced by reverse osmosis, spinning cone centrifuge, distillation or evaporation, or membrane filtration under high pressure to 0.5%-1.5% alcohol. This fraction is then blended with a full-alcohol fraction of wine to achieve a resulting wine that is preferably less than 7% alcohol, although the alcohol content could range from 1% to 10%, with the desired range being from 6.0 to 6.9%, and the preferred level being 6.8% Once the desired alcohol level is achieved, a select amount of flavoring, including a low-calorie or non-calorie sweetener, is added to enhance the flavor of the low-alcohol, low-calorie wine.

Other methods can be used for reducing the alcohol content of the wine, such as using grapes with a lower sugar content before beginning the fermentation process or just be reducing the alcohol content in a full-alcohol content wine directly to the desired alcohol level; however, the inventor has found that starting with a fraction of full alcohol wine, reducing the alcohol content in that fraction of the wine, and then combining that fraction with a full-alcohol fraction is the most preferred method from an economical stand-point of creating a low-alcohol wine in the range of 7% alcohol.

The reduced calorie sweetener which can either be a low-calorie or non-calorie sweetener is preferably added to a fraction of the low alcohol wine and then mixed with the entire fraction.

The amount of low-calorie or non-caloric sweetener mixed with the low-alcohol wine will be a very minor amount, generally less than 5% by weight of the wine, typically less than about 1%, and preferably in the range of 0.0010% to about 0.0060% by weight. Such an amount should generally be sufficient to only subtly modify the flavor of the wine as opposed to overtly sweetening and/or flavoring the same.

Reduced calorie sweeteners, which includes both low-calorie and non-calorie sweeteners, that may be used include: benzosulfamide, commonly known as saccharin; sodium and calcium cyclamates, sold by Zhong Hua Fang Da (H.K.) Ltd.; aspartyl phenylalanine, commonly known as aspartame and sold under the brand Nutrasweet; cholaxine, commonly known as sorbitol; mannitol, an isomer of sorbitol; acesulfame potassium, commonly known as Sunnett, which is produced by Nitrinova, Inc., isomalt which is sold by Paltninit of Morris Plains, N.J.; Litesse II Solution, which is sold by Danisco Sweeteners of Ardsley, N.Y.; lactitol which is also sold by Danisco Sweeteners of Ardsley, N.Y.; neotame which is sold under the brand NutraSweet; alitame which is sold by Pfizer, Inc. of New York, N.Y.; stevia which is sold by Longma Inc. of Santa Ana, Calif.; trucina dulcem, which is sold by Nutrilab Corp. of St. Petersburg, Fla.; Lou Han Guo, which is sold by Full Spectrum Foods, Inc., of City of Industry, Calif.; shugr sold by Swiss Research of Los Angeles, Calif.; talin, sold by Overseal Color, Inc. of Hudson, Wis.; ethyl maltol, sold by Westco Chemicals, Inc. of North Hollywood, Calif.; erthritol, sold by Cerestar USA and Cargill Inc.; xylitol sold by Tagatose SweetGredients GmbH & Co.; trehalose sold by Cargill; dihydrochalcones; glycyrrhizin, sold by Nutri-Meds of Petaluma, Calif.; and trichlorogalactosucrose or sucralose, (sold under the brand Splenda by McNeil Nutritionals LLC) with the preferred sweetener being sucralose.

The first step of the preferred method of making a large volume of low-alcohol, low calorie wine is to identify wine that will be used as the low-alcohol fraction. This can generally be an inexpensive wine or wine of lesser quality than the wine that will be used in the full-alcohol fraction, as the removal of the alcohol from this first fraction of the wine to an approximate level of 0.5% to 1.5% will remove much of the flavor and desirable characteristics from the wine along with the alcohol, so the starting flavor and characteristics of this fraction is not as important as the flavor of the full-alcohol fraction.

During all of the steps of processing the wine it is important to make sure that the wine is free of microbiological growth. Certain microbiological organisms, specifically certain yeast and bacteria have become accustomed to the harsh conditions of full-alcohol wine, and it is believed that those organisms should be more virulent in a low-alcohol wine, so sanitation and monitoring of the wine through all of the processes is important to the delivery of an attractive product to the consumer.

Generally, the reduction of the alcohol in the low-alcohol fraction will be done in a different facility than the mixing facility, so while the full-alcohol fraction is prepared for further operations at the mixing facility, the other fraction is shipped to the alcohol reducing facility.

The full-alcohol fraction is stored in a previously washed and sanitized stainless steel tank, and is preferably cooled to below 40 F with chillers and simultaneously subjected to nitrogen stripping to reach a level of 1.0 ppm dissolved oxygen or less.

The preferred method of stripping the full-alcohol fraction with nitrogen is to employ a common “stripping ‘T’”. It is also preferable that the nitrogen supply be filtered prior to being injected into the low-alcohol fraction. Filtration of this nature can be employed by use of the common “string-wound” types of filters.

Because the cooling and stripping operation can introduce spoilage microorganisms into the full-alcohol fraction, the chillers and the “stripping ‘T’” should be sanitized prior to use.

Once the full-alcohol fraction is cooled to 40 F and stripped with nitrogen to 1.0 ppm, the temperature and oxygen levels should be maintained during blending, processing and storage of the product.

Sulfur dioxide (SO₂) can be added at the time of the cooling/stripping operation. This will be dependent upon the level of SO₂ in the incoming full-alcohol fraction. It can be added as potasium metabisulfite or gaseous sulfur dioxide.

The full-alcohol fraction should be analyzed for the amount of alcohol, total acidity, total sulphur dioxide, volatile acidity and residual sugar, its pH level determined and the results recorded.

As described above, a number of different methods exist for reducing the alcohol content in a fraction of wine. Many of these methods are patented. U.S. Pat. Nos. 4,405,652 and 4,570,534, the specifications of which are incorporated herein by reference, teach reducing the alcohol in wine by evaporating alcohol from the wine in a centrifugal film evaporator. U.S. Pat. Nos. 4,468,407 and 4,902,518, the specifications of which are incorporated herein by reference, teach methods of reducing alcohol in wine by chilling the grape juice to form a low-alcohol solid fraction. U.S. Pat. No. 6,203,826, the specification of which is incorporated herein by reference, teaches separating the grape juice or must produced from the grapes into low-alcohol and high alcohol fractions by either evaporation, freeze concentration, thin film evaporation under reverse pressure and reverse osmosis. U.S. Pat. No. 4,675,191, the specification of which is incorporated herein by reference, teaches oxidizing glucose in unfermented grape juice to gluconic acid to produce a low-alcohol wine. U.S. Pat. Nos. 4,777,688 and 4,816,407, the specifications of which are incorporated herein by reference, teach using membrane extraction to produce a low alcohol wine. U.S. Pat. Nos. 4,976,974 and 4,995,945, the specifications of which are incorporated herein by reference, teach making a low alcohol wine through distillation. U.S. Pat. No. 4,978,547, the specification of which is incorporated herein by reference, teaches making low alcohol wine by evaporation. U.S. Pat. No. 4,999,209, the specification of which is incorporated herein by reference, teaches making a low alcohol wine through double reverse osmosis. U.S. Pat. No. 5,281,430, the specification of which is incorporated herein by reference, teaches an osmotic concentration apparatus that can be used to make low alcohol wine. U.S. Pat. No. 5,385,647, the specification of which is incorporated herein by reference, teaches a method of making a low alcohol wine by pervaporation.

The preferred method of creating the low alcohol fraction that can be combined with a full-alcohol fraction is by reduction in a spinning cone column or stripping column.

Once the low alcohol fraction is made, it is returned to the mixing facility in a stainless steel container which had been thoroughly washed and sanitized prior to being filled with the low alcohol base wine. When the low-alcohol fraction reaches the processing facility, it must be unloaded into a previously washed and sanitized stainless steel tank. Upon completion of the offloading process, the low-alcohol fraction is preferably cooled to below 40 F with chillers and simultaneously subjected to nitrogen stripping to reach a level of 1.0 ppm dissolved oxygen or less, using the same methods described above for the full-alcohol fraction.

As above, once the low-alcohol fraction is cooled to 40 F and stripped with nitrogen to 1.0 ppm, the temperature and oxygen levels should be maintained during blending, processing and storage of the product.

Sulfur dioxide (SO₂) can be added at the time of the cooling/stripping operation. This will be dependent upon the level of SO₂ in the incoming low-alcohol fraction. It can be added as potasium metabisulfite or gaseous sulfur dioxide.

The low alcohol fraction should be analyzed for the amount of alcohol, total acidity, total sulphur dioxide, volatile acidity and residual sugar, its pH level determined and the results recorded.

To ensure best results, it is preferable to make a laboratory bend with small amounts of each fraction before performing the actual cellar blend.

A small amount of the low-alcohol fraction is combined with the full-alcohol fraction, as well as the remaining ingredients. This blend is analyzed for alcohol, and preferably it will fall within the range of 6.8%±0.1%. If this alcohol range is met, the laboratory blend will then be filtered through diatomaceous earth, analyzed for the amount of alcohol, total acidity, total sulphur dioxide, volatile acidity and residual sugar, its pH level determined and tasted for approval.

If the final laboratory blend is approved and if the analytical parameters of that blend are within specifications, the cellar blend can be made according to the ratios determined in the laboratory.

Once the two fractions are combined in the ratios determined in the laboratory, the combined blend is stripped with nitrogen to achieve a dissolved oxygen content of 1.0 ppm or less, returned to a temperature of 40 F or below by chilling and analyzed for the amount of alcohol, total acidity, total sulphur dioxide, volatile acidity and residual sugar, and its pH level determined. At this point, it is preferable to also analyze the blend for heat and cold stability.

If the cellar blend is not heat stable, a series of bentonite addition trials will be performed on samples of the blend in the laboratory. Through these trials, the appropriate level of bentonite required to achieve stability is determined. Upon completion of these trials, the appropriate bentonite addition will be done in the cellar to the combined blend. In addition to the bentonite, a small amount of gelatin (⅛ lb/1000 gallons) may be added to facilitate settling of the bentonite. After the bentonite settles, filtration will be required to achieve clarity.

If the cellar blend is not cold stable, the blend must be further cooled to between 32 F and 34 F to achieve cold stability. At the end of the cooling operation, the level of dissolved oxygen in the product should be returned to less than 1.0 ppm by nitrogen stripping. The cooling will cause the formation of crystalline deposits, and they must be removed. This is done by allowing the precipitate to settle for a minimum of two weeks. After at least two weeks have passed, the temperature of the wine is checked, and if the temperature of the cellar blend has risen to above 36 F, the cellar blend should be re-cooled to between 32 F and 34 F and pressure filtered to remove the crystals. After the filtration, the cellar blend should be analyzed for alcohol, total acidity, and the pH level determined.

After all cellar treatments on the cellar blend are completed, a second laboratory blend will be made to confirm the level of additives. This blend will consist of the low-alcohol cellar bend, whose alcohol content is preferably 6.8%, and the additional flavorings. If the laboratory blend is approved, the cellar blend can proceed to final product.

The additional flavorings are added to the cellar blend by drawing off a fraction of the cellar blend into a mixing tub in which the additional ingredients can be dissolved, and adding the additional ingredients to the mixing tub. The contents of this tub are then mixed with nitrogen and then pumped back into the tank containing the cellar blend.

The additional flavoring includes the non-caloric sweetener, preferably sucralose, which adds no calories, and any other flavorings as desired. Additional flavors can be such flavors as oak, and include the flavors identified as Allen Flavors Oak Typ A1 AF11007 and Allen Flavors Oak Typ A2 AF11127.

The resulting wine in the tank is then nitrogen stripped and sampled for complete analysis which consists of the amount of alcohol, total acidity, total sulphur dioxide, volatile acidity and residual sugar, its pH level and heat and cold stability. The resulting wine is evaluated for taste as well as for the characteristics specified above.

If approved, the resulting wine is prepared for bottling by undergoing bottle polish filtration. This resulting wine should be filtered through 0.451 membrane filters.

If the resulting wine must wait a substantial amount of time before it can be bottled, just before it is bottled it should be analyzed again for oxygen, the amount of alcohol, total acidity, total sulphur dioxide, volatile acidity and residual sugar, its pH level, as well as taste. If all analytical and taste parameters are met, the product can be released for bottling.

During bottling, the resulting wine is cold filtered through 0.45i membranes. In some instances it may be desirable to inject Velcorin into the product during the bottling operation. Once bottled, the wine is ready for sale.

During the process, it may also be necessary to add activated carbon to the wine in a ratio of 25 pounds per 1,000 gallons of wine, and to add sorbic acid and potassium sorbate or, instead of the sorbic acid, demethyl dicarbonate to stabilize the wine.

What is claimed is:

1. A method of modifying the flavor of a low-alcohol wine comprising mixing a major amount by weight of a low-alcohol wine with a minor amount by weight of a reduced-calorie sweetener composition.

2. The method of claim 1, wherein the minor amount of the reduced-calorie sweetener is less than 5% by weight of the mixture.

3. The method of claim 2, wherein the low-alcohol wine has an alcohol content that is approximately in the range between 1% and 10% by volume of the mixture.

4. The method of claim 1, wherein the minor amount of the reduced-calorie sweetener is approximately between 0.0010% and 1.0% by weight of the mixture.

5. The method of claim 4, wherein the low-alcohol wine has an alcohol content that is less than 10% by volume of the mixture.

6. The method of claim 4, wherein the low-alcohol wine has an alcohol content that is less than 7% by volume of the mixture.

7. The method of claim 1, wherein the minor amount of the reduced-calorie sweetener is approximately between 0.0010% and 0.0060% by weight of the mixture.

8. The method of claim 7, wherein the low-alcohol wine has an alcohol content that is less than 10% by volume of the mixture.

9. The method of claim 7, wherein the low-alcohol wine has an alcohol content that is less than 7% by volume of the mixture.

10. The method of claim 1, wherein the reduced-calorie sweetener is sucralose.

11. The method of claim 4, wherein the reduced-calorie sweetener is sucralose.

12. The method of claim 6, wherein the reduced-calorie sweetener is sucralose.

13. The method of claim 7, wherein the reduced-calorie sweetener is sucralose.

14. The method of claim 9, wherein the reduced-calorie sweetener is sucralose.

15. The method of claim 14, wherein the low-alcohol wine is produced by taking a first fraction of wine and reducing the alcohol content of the first fraction, and combing the first fraction of wine with a second fraction of wine that is other than the wine used for the first fraction of wine.

16. A beverage composition comprising a major amount by weight of a low-alcohol wine, having an alcohol content less than 10% by volume, and a minor amount by weight of a reduced-calorie sweetener, the minor amount being less than 5% by weight of the resulting mixture.

17. The composition of claim 7, wherein the minor amount of the reduced-calorie sweetener is less than 1% by weight of the mixture.

18. The composition of claim 17, wherein the reduced calorie sweetener is sucralose.

19. The composition of claim 16, wherein the low-alcohol wine has an alcohol content less than 7% by volume, and the minor amount of the reduced-calorie sweetener is approximately between 0.0010% and 0.0060% by weight of the mixture.

20. The composition of claim 19, wherein the reduced calorie sweetener is sucralose.

21. The composition of claim 20, wherein the low-alcohol wine is produced by taking a first fraction of wine and reducing the alcohol content of the first fraction, and combing the first fraction of wine with a second fraction of wine that is other than the wine used for the first fraction of wine.
